(19) United States
(12) Patent Application Publication
(10) Pub. No.: US 2023/0185772 A1
(43) Pub. Date: Jun. 15, 2023

(54) INODE NUMBER DISTRIBUTION MANAGEMENT METHOD FOR DISTRIBUTED STORAGE SYSTEM AND RELATED COMPONENT

(71) Applicant: SUZHOU INSPUR INTELLIGENT TECHNOLOGY CO., LTD, Suzhou, Jiangsu (CN)

(72) Inventors: Hao LUO, Suzhou, Jiangsu (CN); Jie LI, Suzhou, Jiangsu (CN)

(21) Appl. No.: 18/011,348

(22) PCT Filed: Feb. 20, 2021
(86) PCT No.: PCT/CN2021/076973

§ 371 Date: Dec. 19, 2022

(30) Foreign Application Priority Data
Jun. 29, 2020 (CN) 202010623499.7

(51) Int. Cl. G06F 16/182; G06F 16/14

(52) U.S. Cl. CPC G06F 16/182; G06F 16/14

(57) ABSTRACT

An Inode number distribution management method and apparatus for a distributed storage system, and a device and a readable storage medium. The method includes: performing recycling monitoring on a client distributed with an Inode number; if the client connection is abnormal or after metadata is deleted, performing node number recycling processing on the Inode number without the corresponding metadata; re-putting the recycled Inode number into an available Inode number resource; and when the client requests to distribute the Inode number, distributing Inode numbers according to the available Inode number resources, to recycle the Inode number. It is guaranteed that each Inode number is fully utilized under limited Inode number resources, the use amount of the whole Ino is saved, and the number of files stored by the distributed file system under the limited Inode number resources is increased.

### CROSS REFERENCE TO RELATED APPLICATION

The present disclosure claims the priority of the Chinese patent application filed on June 29^{th}, 2020 before the CNIPA, China National Intellectual Property Administration with the application number of 202010623499.7 and the title of “INODE NUMBER DISTRIBUTION MANAGEMENT METHOD FOR DISTRIBUTED STORAGE SYSTEM AND RELATED COMPONENT”, which is incorporated herein in its entirety by reference.

### FIELD

The present application relates to the technical field of distributed file systems and, more particularly, to a method, apparatus and device for managing allocation of Inode numbers of the distributed storage system and a readable storage medium.

### BACKGROUND

In a distributed file system, each file has a corresponding Inode in which metadata information related to the file is recorded. Each Inode has a number (abbreviated as Inode number or Ino) by which the file system identifies the different files.

Each creation operation in a distributed file system requires a proprietary Ino (Inode number) to be allocated. At present, Inos are allocated in the distributed file system in an increasing sequence. With the generation of more and more mass data, Inos are not inexhaustible and would cause a great waste with the release of more and more garbage data.

Therefore, how to save the Inos used to further increase the number of files that may be stored in a distributed file system is a problem to be solved by a person skilled in the art.

### SUMMARY

An object of the present application is to provide a method for managing allocation of Inode numbers of a distributed storage system, wherein the method may save the Inos usage to further increase the number of files storable by the distributed file system; another object of the present application is to to provide a device, apparatus for managing allocation of Inode numbers of the distributed storage system and a readable storage medium.

In order to solve the above-mentioned technical problem, the present application provides a method for managing allocation of Inode numbers for a distributed storage system, which includes:
after an InoTable in a primary metadata server (MDS) receiving an Inode number configuration application initiated by the MDS, allocating Inode numbers for the MDS according to the currently available Inode number resource to invoke the Inode number to respond to a metadata creation request of a client;
after receiving a client connection abnormality recovery notification, determining Inode numbers allocated for the client in abnormality connection, and determining unused Inode numbers among the Inode numbers;
performing node number recovery processing on the unused Inode numbers;
after receiving a metadata deletion recovery notification, determining Inode numbers for executing the metadata deletion operation;
executing node number recovery processing on the Inode number executing the metadata deletion operation; and
adding the recovered Inode number to the available Inode number resource.

In an embodiment of the present disclosure, after the InoTable in the primary MDS receiving the Inode number configuration application initiated by the MDS, allocating Inode numbers for the MDS according to the currently available Inode number resource to invoke the Inode number to respond to the metadata creation request of the client, including:

after the InoTable in the primary MDS receiving the Inode number configuration application initiated by the MDS, allocating, by the InoTable in the primary MDS, a batch Inode number for the MDS according to the currently available Inode number resource, so that the Inode number invokes the batch Inode number to respond to several times of metadata creation requests of the client; wherein the batch Inode number includes at least two Inode numbers.

In an embodiment of the present disclosure, after the InoTable in the primary MDS receiving the Inode number configuration application initiated by the MDS, allocating Inode numbers for the MDS according to the currently available Inode number resource to invoke the Inode number to respond to the metadata creation request of the client, including:

after the InoTable in the primary MDS receiving the Inode number configuration application initiated by the MDS, allocating the Inode numbers for the MDS from the currently available Inode number resource according to an order that an allocated priority recovery node is higher than the unallocated node number to invoke the Inode number to respond to the metadata creation request of the client.

The present application also provides a device for managing allocation of Inode numbers of the distributed storage system, applied to an InoTable in a primary MDS, the device including:
a resource allocation unit configured for, after receiving an Inode number configuration application initiated by the MDS, allocating Inode numbers for the MDS according to the currently available Inode number resource to invoke the Inode number to respond to a metadata creation request of a client;
an abnormality processing unit configured for, after receiving a client connection abnormality recovery notification, determining Inode numbers allocated for the client in abnormality connection, and determining unused Inode numbers among the Inode numbers;
an abnormality recovery unit configured for performing node number recovery processing on the unused Inode numbers;
a deletion processing unit configured for, after receiving a metadata deletion recovery notification, determining Inode numbers for executing the metadata deletion operation;
a deletion recovery unit configured for performing node number recovery processing on the Inode number executing the metadata deletion operation; and
a recovery node adding unit configured for adding a recovered Inode number to the available Inode number resource.

The present application also provides a method for managing allocation of Inode numbers of a distributed storage system, including:
after an MDS receiving a metadata creation request of a client, applying an Inode number configuration to an InoTable of a primary MDS for the client;
after receiving the Inode number allocated by the InoTable, invoking the Inode number to respond to the metadata creation request;
on a condition that a client connection abnormality is detected, informing the InoTable to recover unused Inode numbers in the client; and
on a condition that the client executes a metadata deletion operation, informing the InoTable to recover an Inode number executing the metadata deletion operation in the client after data release is completed.

In an embodiment of the present disclosure, on the condition that the client connection abnormality is detected, informing the InoTable to recover unused Inode numbers in the client, including:

on the condition that it is detected that the client mount point is uninstalled or power is lost to disconnect the link, determining that the client connection is abnormal, and informing the InoTable to recover the unused Inode numbers in the client.

The present application also provides a device for managing allocation of Inode numbers of the distributed storage system, applied to an MDS, the device including:
a configuration application unit configured for, after receiving a metadata creation request of a client, applying an Inode number configuration to an InoTable of a primary MDS for the client;
a creation response unit configured for, after receiving the Inode number allocated by the InoTable, invoking the Inode number to respond to the metadata creation request;
an abnormality notification unit configured for on a condition that a client connection abnormality is detected, informing the InoTable to recover unused Inode numbers in the client; and
a deletion notification unit configured for, on a condition that the client executes a metadata deletion operation, informing the InoTable to recover an Inode number executing the metadata deletion operation in the client after data release is completed.

In an embodiment of the present disclosure, the abnormality notification unit is: a first notification unit configured for, on the condition that it is detected that the client mount point is uninstalled or power is lost to disconnect the link, determining that the client connection is abnormal, and informing the InoTable to recover the unused Inode numbers in the client.

The present application also provides a computer apparatus including:
a memory configured for storing a computer program;
a processor configured for implementing the steps of the method for managing allocation of Inode numbers of the distributed storage system applied to the InoTable in the primary MDS and/or the steps of the method for managing allocation of Inode numbers of the distributed storage system applied to the MDS when executing the computer program.

The present application also provides a readable storage medium having stored thereon a program which, when executed by a processor, implements the steps of the method for managing allocation of Inode numbers of the distributed storage system applied to the InoTable in the primary MDS and/or the steps of the method for managing allocation of Inode numbers of the distributed storage system applied to the MDS when executing the computer program.

A method for managing allocation of Inode numbers of the distributed storage system provided in the present application, the method includes performing recovery monitoring for a client which allocates an Inode number. On the condition that the client connection is abnormal or after metadata is deleted, performing node number recovery processing on an Inode number which does not have corresponding metadata and re-putting the recovered Inode number into an available Inode number resource, to allocate the Inode number according to the available Inode number resource when the client requests to allocate the Inode number, thereby achieving the recovery and reuse of the Inode number, guaranteeing that each Inode number is fully utilized under the limited Inode number resources, to save the use of the overall Ino and improve the number of files that may be stored in the distributed file system under the limited Inode number resources.

The present application also provides a device, apparatus for managing allocation of Inode numbers of the distributed storage system and a readable storage medium, with the above-mentioned beneficial effects, which will not be described in detail herein.

### BRIEF DESCRIPTION OF THE DRAWINGS

In order to more clearly explain the technical solution in the embodiment or the existing technology of the present disclosure, the following will briefly introduce the drawings that need to be used in the embodiment or the existing technology description. Obviously, the drawings in the following description are only the embodiment of the present disclosure. For a person skilled in the art, other drawings may be obtained according to the provided drawings without paying creative labor.

FIG. 1 is a signaling diagram of a method for managing allocation of Inode numbers of the distributed storage system according to an embodiment of the present application;

FIG. 2 is a block diagram showing the structure of a device for managing allocation of Inode numbers of the distributed storage system applied to InoTable in a primary MDS according to an embodiment of the present application

FIG. 3 is a block diagram showing the structure of a device for managing allocation of Inode numbers of the distributed storage system applied to an MDS according to an embodiment of the present application; and

FIG. 4 is a schematic structural diagram of a computer apparatus according to an embodiment of the present application.

### DETAILED DESCRIPTION

An object of the present application is to provide a method for managing allocation of Inode numbers for a distributed storage system, wherein the method may save the Inos usage to further increase the number of files storable by the distributed file system; another object of the present application is to provide a device, apparatus for managing allocation of Inode numbers of the distributed storage system and a readable storage medium.

In order that the objects, aspects and advantages of the embodiments of the present application will become more apparent, a more complete description of the embodiments of the present application will be rendered by reference to the appended drawings, which are provided for purposes of illustration and are not intended to be exhaustive or limiting of the present application. Based on the embodiments in the present application, all other embodiments obtained by a person skilled in the art without involving any inventive effort are within the scope of protection of the present application.

A primary MDS (Metadata server cluster, a metadata server) and a non-primary MDS (abbreviated as MDS in the present application) are included in a metadata service cluster; in the embodiment, the primary MDS undertakes to manage the allocation and recovery of Inos, and the MDS undertakes metadata operation interaction with a client; a client behavior is monitored through the MDS; and after a client connection is abnormal or a metadata deletion operation is executed, a node number is recovered by an InoTable (Inode table, service for managing Inos in the primary MDS) in the primary MDS, and is still served as an available Inode number resource for reallocation after recovery, and reuse of the Inode number may be realized, thereby saving the Inos usage and the number of files which may be stored in a distributed file system is increased.

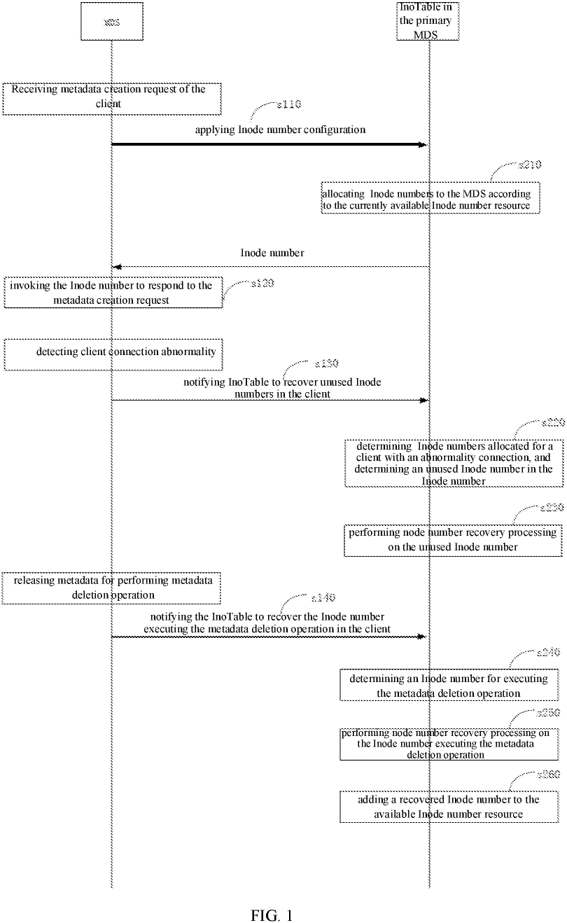

With reference to FIG. 1, FIG. 1 is a signaling diagram of a method for managing allocation of Inode numbers of the distributed storage system according to an embodiment of the present application, and the method mainly involves two ends: a primary MDS and a non-primary MDS (abbreviated as MDS), both ends interacting to complete Ino allocation management in the embodiment, and the method mainly includes the following steps:

step s110, after an MDS receiving a metadata creation request of a client, applying an Inode number configuration to an InoTable of a primary MDS for the client;

sending a metadata operation request to the MDS when a client process creates an operation, and the MDS will apply for Ino (Inode number) allocation to InoTable (a service for managing Inos in the primary MDS) in the primary MDS.

Step s210, after an InoTable in a primary MDS receiving an Inode number configuration application initiated by the MDS, allocating Inode numbers for the MDS according to the currently available Inode number resource to invoke the Inode number to respond to a metadata creation request of a client;

After the InoTable in the primary MDS receives the Inode number configuration application initiated by the MDS, the InoTable will allocate the Ino for the requested MDS according to the currently available Inode number resources, wherein the Ino allocation mechanism is not limited in this embodiment and may be set accordingly for actual usage requirements.

Step s120, after the MDS receiving the Inode number allocated by the InoTable, invoking the Inode number to respond to the metadata creation request;

The execution of the MDS responsing the metadata operation of the client according to the allocated Ino may refer to an implementation of the related art, which is not limited in the embodiment.

Step s130, on a condition that a client connection abnormality is detected by the MDS, informing the InoTable to recover unused Inode numbers in the client;

the MDS detects a client connection abnormality and notifies the InoTable to recover unused Inode numbers in the client, wherein the connection abnormality refers to a connection abnormality between the client and the MDS, and normal interaction between the client and the MDS cannot be realized; in the embodiment, the detection and determination method of the client connection abnormality are not limited; and in an embodiment of the present disclosure, when detecting that a client mount point unloads or a power failure disconnects, the client connection abnormality is determined and the InoTable is informed to recover the unused Inode numbers in the client.

Step s220, after receiving a client connection abnormality recovery notification by the InoTable in the primary MDS, determining Inode numbers allocated for a client in abnormality connection, and determining unused Inode numbers among the Inode numbers;

When an InoTable in a primary MDS allocates an Ino to each MDS, a record is generated, which Ino are allocated to which client of which MDS, and which Ino may be recorded; the Ino allocated by a client with an abnormal current connection may be determined according to the record information, and which are not used are determined according to a usage record of the client Ino; and the Ino which are not used are recovered as to realize the reuse of the Ino.

Step s230, the InoTable in the primary MDS performs node number recovery processing on an unused Inode number;

In the primary MDS, the InoTable executing node number recovery processing on the Inode number may delete the relevant data of the MDS originally allocated to the recovered node number and re-add same to the available Inode number resources. The implementation process is merely described by taking the above-mentioned manner as an example, and other recovery manners may all be described with reference to the description of the embodiment, which will not be described in detail herein.

In step s140, on a condition that the client executes a metadata deletion operation, informing the InoTable to recover an Inode number executing the metadata deletion operation in the client after data release is completed.

When the client performs the deletion operation, after the metadata is processed in MDS and the actual data release is completed, InoTable is informed to recover the Ino performing the deletion operation.

Step s240, after receiving a metadata deletion recovery notification by the InoTable in the primary MDS, determining Inode numbers for executing the metadata deletion operation;

after the metadata corresponding to the Inode number is deleted, determining the Inode number corresponding to the deleted metadata.

Step s250, performing, by the InoTable in the primary MDS, node number recovery processing on the Inode number executing the metadata deletion operation;

Note that the process of recovering the node number for the Inode number corresponding to the metadata deletion should be performed after the metadata deletion is completed, to avoid the destruction of the original metadata.

The process of performing the node number recovery process on the Inode number executing the metadata deletion operation may refer to an implementation process of performing the node number recovery process on the unused Inode number, and will not be described in detail herein.

In step s260, adding, by the InoTable in the primary MDS, the recovered Inode number to the available Inode number resource.

The recovered Inode number may include an unused Inode number recovered due to client connection abnormality, and may also include an Inode number corresponding to an Inode after deleting metadata, and the recovered Inode number is added to an available Inode number resource, so that the InoTable in the primary MDS reuses these Inode numbers, thereby ensuring the long-term and effective configuration implementation of the Inode number under the limited Inode number resource.

Based on the above-mentioned introduction, the method for managing allocation of Inode numbers of the distributed storage system provided in the embodiment includes performing recovery monitoring for a client which allocates an Inode number. On the condition that the client connection is abnormal or after metadata is deleted, performing node number recovery processing on an Inode number which does not have corresponding metadata, and re-putting the recovered Inode number into an available Inode number resource, to allocate the Inode number according to the available Inode number resource when the client requests to allocate the Inode number, thereby achieving the recovery and reuse of the Inode number, guaranteeing that each Inode number is fully utilized under the limited Inode number resources, to save the use of the overall Ino and improve the number of files that may be stored in the distributed file system under the limited Inode number resources.

The implementation of the Ino allocation mechanism in the above-mentioned embodiment is not limited, and the Ino allocation of the InoTable in the primary MDS is mainly described in this embodiment.

The Ino allocation of the InoTable in the primary MDS may be allocated separately, i.e. a single Ino is allocated for the Ino after receiving the request, or multiple Inos may be allocated after receiving the request, for the client to use multiple requests later.

Optionally, an allocation mechanism is as follows: after receiving an index node number configuration application initiated by the MDS, the InoTable in the primary MDS allocates a batch index node number for the MDS according to the currently available Inode number resource, so that the Inode number invokes the batch index node number to respond to several times of metadata creation requests of the client; wherein at least two Inode numbers are least two Inode numbers.

One implementation based on the above-mentioned allocation mechanism is as follows:

(1) when an A client first performs a creation operation, the client applies for a certain MDS to perform a metadata operation, and the MDS first applies for an Ino configuration from the InoTable of the primary MDS.

(2) InoTable will allocate a batch of Inos to client A in advance and inform client A of these allocated Inos.

(3) When the A client creates an operation again, it gets the use directly from the pre-allocated Ino number without applying again to InoTable.

(4) When the use of the pre-allocated Inos by the A client is completed, the application is applied to the InoTable again.

The above-mentioned allocation mechanism successively allocates a plurality of Inos to the client after the primary MDS receives the metadata allocation request, and when the client initiates the creation operation again, the client will obtain use directly from the Ino segment applied last time without applying for the Ino operation again. This batch Ino allocation scheme may simplify the primary MDS’s Ino allocation process, reduce the primary MDS’s Ino allocation times, and improve the Ino allocation management efficiency.

In the embodiment, only the above-mentioned batch distribution mode is used as an example, and other Ino distribution modes based on the present application may be referred to the description of the embodiment and will not be described again.

In addition, after receiving an Inode number configuration application initiated by the MDS, the InoTable in the primary MDS allocates Inode numbers for the MDS according to the currently available Inode number resource, wherein the available Inode number resource contains all currently allocatable Inos, including recovered Inos, and also including Inos which are not always allocated, wherein the implementation method for selecting the Inos to be allocated from the available Ino resources is not limited. Alternatively, one implementation is as follows: after the InoTable in the primary MDS receiving the Inode number configuration application initiated by the MDS, allocating the Inode numbers for the MDS from the currently available Inode number resource according to an order that an allocated priority recovery node is higher than the unallocated node number to invoke the Inode number to respond to the metadata creation request of the client.

When a client initiates a creation operation, and Inos are to be applied to the InoTable of the primary MDS, the InoTable allocates from those Inos which have been recovered, to ensure the excellent continuity of available Ino resources; on the condition that the recovered Inos are insufficient, new Inos are allocated, thereby improving the use efficiency of the Inos.

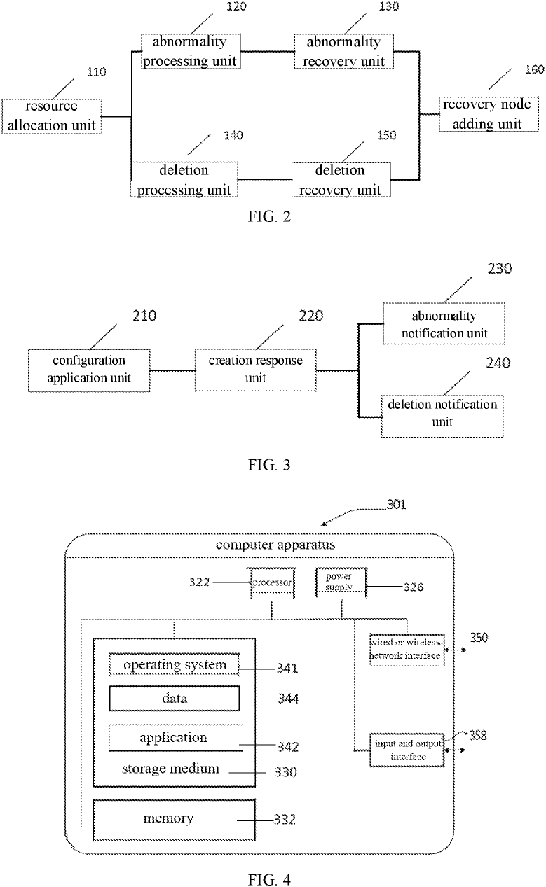

With reference to FIG. 2, FIG. 2 is a structural block diagram of a device for managing allocation of Inode numbers of the distributed storage system provided in the embodiment; the device is applied to InoTable in the primary MDS, and the device mainly includes: a resource allocation unit 110, an abnormality processing unit 120, an abnormality recovery unit 130, a deletion processing unit 140, a deletion recovery unit 150, and a recovery node adding unit 160. The device for managing allocation of Inode numbers of the distributed storage system provided in the embodiment may be compared with the above-mentioned method for managing allocation of Inode numbers of a distributed storage system.

Wherein the resource allocation unit 110 configured for, after receiving an Inode number configuration application initiated by the MDS, allocating Inode numbers for the MDS according to the currently available Inode number resource to invoke the Inode number to respond to a metadata creation request of a client;
the abnormality processing unit 120 configured for, after receiving a client connection abnormality recovery notification, determining Inode numbers allocated for the client in abnormality connection, and determining unused Inode numbers among the Inode numbers;
the abnormality recovery unit 130 configured for performing node number recovery processing on the unused Inode numbers;
the deletion processing unit 140 configured for, after receiving a metadata deletion recovery notification, determining Inode numbers for executing the metadata deletion operation;
the deletion recovery unit 150 configured for performing node number recovery processing on the Inode number executing the metadata deletion operation; and
the recovery node adding unit 160 configured for adding a recovered Inode number to the available Inode number resource.

With reference to FIG. 3, which is a block diagram showing the structure of the device for managing allocation of Inode numbers of the distributed storage system provided in the embodiment; the device is applied to MDS, and the device mainly includes: a configuration application unit 210, a creation response unit 220, an abnormality notification unit 230, and a deletion notification unit 240 are configured. The device for managing allocation of Inode numbers of the distributed storage system provided in the embodiment may be compared with the above-mentioned method for managing allocation of Inode numbers for a distributed storage system.

The configuration application unit 210 is mainly configured for, after an MDS receiving a metadata creation request of a client, applying an Inode number configuration to an InoTable of a primary MDS for the client;
the creation response unit 220 is mainly configured for, after receiving the Inode number allocated by the InoTable, invoking the Inode number to respond to the metadata creation request;
the abnormality notification unit 230 is mainly configured for on a condition that a client connection abnormality is detected, informing the InoTable to recover unused Inode numbers in the client;
the deletion notification unit 240 is mainly configured for on a condition that the client executes a metadata deletion operation, informing the InoTable to recover an Inode number executing the metadata deletion operation in the client after data release is completed.

Alternatively, the abnormality notification unit 230 may be: a first notification unit configured for: on the condition that it is detected that the client mount point is uninstalled or power is lost to disconnect the link, determining that the client connection is abnormal, and informing the InoTable to recover the unused Inode numbers in the client.

The embodiment provides a computer apparatus mainly including: a memory and a processor.

Wherein the memory is configured for storing a program;

when a processor is used to execute a program, the steps of the method for managing allocation of Inode numbers of the distributed storage system as described in the above-mentioned embodiment are implemented, and reference may be made to the above-mentioned description of the method for managing allocation of Inode numbers for a distributed storage system.

Referring to FIG. 4, a schematic structural diagram of a computer apparatus that may vary widely in configuration or performance and that may include one or more central processing units (CPU) 322 (e.g. one or more processors) and a memory 332, one or more storage mediums 330 (e.g. one or more mass storage apparatuses) that store applications 342 or data 344. The memory 332 and storage mediums 330 may be transient storage or persistent storage. A program stored on the storage medium 330 may include one or more modules (not shown), each of which may include a series of instruction operations on a data processing apparatus. Still further, the central processing unit 322 may be configured to communicate with the storage medium 330 to execute a series of instruction operations on the storage medium 330 on the computer apparatus 301.

The computer apparatus 301 may also include one or more power supplies 326, one or more wired or wireless network interfaces 350, one or more input and output interfaces 358, and/or one or more operating systems 341, such as Windows ServerTM, Mac OS XTM, UnixTM, LinuxTM, FreeBSDTM, etc.

The steps in the method for managing allocation of Inode numbers of the distributed storage system described above with reference to FIG. 1 may be implemented by the architecture of the computer apparatus described by this embodiment.

The embodiment discloses a readable storage medium, on which a program is stored, and when the program is executed by a processor, the steps of a method for managing allocation of Inode numbers of the distributed storage system as described in the above-mentioned embodiment are implemented, and reference may be made to the above-mentioned embodiment for the description of the method for managing allocation of Inode numbers for a distributed storage system.

The readable storage medium may be a U-disk, a removable hard disk, a Read-Only Memory (ROM), a Random Access Memory (RAM), a magnetic disk or an optical disk which may store a program code.

Various embodiments are described in the ation progressively, with each embodiment focusing on differences from the other embodiments, and with reference to one another, the embodiments have their same or similar parts explained. The system disclosed in the embodiments corresponds to the method disclosed in the embodiments, and is thus described in a relatively simple manner, that is, reference may be made to the embodiments of the method to understand the relevant parts of the system.

A person skilled in the art may further realize that the units and algorithm steps of each example described in combination with the examples disclosed herein may be realized by electronic hardware, computer software or a combination of the two. In order to clearly explain the interchangeability of hardware and software, the composition and steps of each example have been described generally according to the functions in the above instructions. Whether these functions are implemented in hardware or software depends on the application and design constraints of the technical solution. A person skilled in the art may use different methods to implement the described functions for each application, but this implementation should not be considered beyond the scope of the invention.

The steps of the method or algorithm described in combination with the embodiment described in the ation may be directly implemented by hardware, software modules executed by the processor, or a combination of the two. Software modules may be placed in random access memory (RAM), memory, read-only memory (ROM), electrically programmable ROM, electrically erasable programmable ROM, register, hard disk, removable disk, CD-ROM, or any other form of storage medium known in the art.

The method, apparatus and device for managing allocation of Inode numbers of the distributed storage system and the readable storage medium provided by the present application above are described in detail. In this ation, examples are used to explain the principle and implementation of the present application. The embodiments above are only used to help understand the method and core idea of the present application. It should be pointed out that for a person skilled in the art, some improvements and modifications may be made to the present application without deviating from the principle of the present application. These improvements and modifications also fall within the scope of protection of the claims in the present application.

1. A method for managing allocation of Inode numbers of a distributed storage system, comprising:
after an InoTable in a primary metadata server (MDS) receiving an Inode number configuration application initiated by the MDS, allocating Inode numbers for the MDS according to the currently available Inode number resource to invoke the Inode number to respond to a metadata creation request of a client;
after receiving a client connection abnormality recovery notification, determining Inode numbers allocated for the client in abnormality connection, and determining unused Inode numbers among the Inode numbers;
performing node number recovery processing on the unused Inode numbers;
after receiving a metadata deletion recovery notification, determining Inode numbers for executing the metadata deletion operation;
executing node number recovery processing on the Inode number executing the metadata deletion operation; and
adding the recovered Inode number to the available Inode number resource.

2. The method for managing allocation of Inode numbers of the distributed storage system according to claim 1, wherein after the InoTable in the primary MDS receiving the Inode number configuration application initiated by the MDS, allocating Inode numbers for the MDS according to the currently available Inode number resource to invoke the Inode number to respond to the metadata creation request of the client comprises:
after the InoTable in the primary MDS receiving the Inode number configuration application initiated by the MDS, allocating, by the InoTable in the primary MDS, a batch Inode number for the MDS according to the currently available Inode number resource, so that the Inode number invokes the batch Inode number to respond to several times of metadata creation requests of the client; wherein the batch Inode number comprises at least two Inode numbers.

3. The method for managing allocation of Inode numbers of the distributed storage system according to claim 1, wherein after the InoTable in the primary MDS receiving the Inode number configuration application initiated by the MDS, allocating Inode numbers for the MDS according to the currently available Inode number resource to invoke the Inode number to respond to the metadata creation request of the client comprises:
after the InoTable in the primary MDS receiving the Inode number configuration application initiated by the MDS, allocating the Inode numbers for the MDS from the currently available Inode number resource according to an order that an allocated priority recovery node is higher than the unallocated node number to invoke the Inode number to respond to the metadata creation request of the client.

4. (canceled)

5. A method for managing allocation of Inode numbers of a distributed storage system, comprising:
after an MDS receiving a metadata creation request of a client, applying an Inode number configuration to an InoTable of a primary MDS for the client;
after receiving the Inode number allocated by the InoTable, invoking the Inode number to respond to the metadata creation request;
on a condition that a client connection abnormality is detected, informing the InoTable to recover unused Inode numbers in the client; and
on a condition that the client executes a metadata deletion operation, informing the InoTable to recover an Inode number executing the metadata deletion operation in the client after data release is completed.

6. The method for managing allocation of Inode numbers of the distributed storage system according to claim 5, wherein on the condition that the client connection abnormality is detected, informing the InoTable to recover unused Inode numbers in the client, comprises:
on the condition that it is detected that the client mount point is uninstalled or power is lost to disconnect the link, determining that the client connection is abnormal, and informing the InoTable to recover the unused Inode numbers in the client.

7. (canceled)

8. (canceled)

9. A computer apparatus, comprising:
a processor; and
a memory, storing a computer program that is executed by the processor, and upon execution by the processor, is configured to cause the processor to implement operations comprising:
after an InoTable in a primary metadata server (MDS) receiving an Inode number configuration application initiated by the MDS, allocating Inode numbers for the MDS according to the currently available Inode number resource to invoke the Inode number to respond to a metadata creation request of a client;
after receiving a client connection abnormality recovery notification, determining Inode numbers allocated for the client in abnormality connection, and determining unused Inode numbers among the Inode numbers;
performing node number recovery processing on the unused Inode numbers;
after receiving a metadata deletion recovery notification, determining Inode numbers for executing the metadata deletion operation;
executing node number recovery processing on the Inode number executing the metadata deletion operation; and
adding the recovered Inode number to the available Inode number resource.

10. A computer-readable storage medium, storing a computer program that is executed by a processor, and upon execution by the processor, is configured to cause the processor to implement the steps of the method for managing allocation of Inode numbers of the distributed storage system according to claim 1.

11. The method for managing allocation of Inode numbers of the distributed storage system according to claim 1, wherein the connection abnormality refers to a connection abnormality between the client and the MDS.

12. The method for managing allocation of Inode numbers of the distributed storage system according to claim 1, wherein when the InoTable in the primary MDS allocates the Inode number to each MDS, a record is generated.

13. The method for managing allocation of Inode numbers of the distributed storage system according to claim 1, wherein the InoTable in the primary MDS performs node number recovery processing on an unused Inode number comprises:
deleting relevant data of the MDS originally allocated to recovered node number and re-adding the recovered node number to the available Inode number resources.

14. The method for managing allocation of Inode numbers of the distributed storage system according to claim 1, wherein before executing node number recovery processing on the Inode number executing the metadata deletion operation, the metadata deletion is completed.

15. The method for managing allocation of Inode numbers of the distributed storage system according to claim 1, wherein the recovered Inode number comprises at least one of an unused Inode number recovered due to the connection abnormality and an Inode number corresponding to an Inode after deleting the metadata.

16. The computer apparatus according to claim 9, wherein after the InoTable in the primary MDS receiving the Inode number configuration application initiated by the MDS, allocating Inode numbers for the MDS according to the currently available Inode number resource to invoke the Inode number to respond to the metadata creation request of the client, comprising:
after the InoTable in the primary MDS receiving the Inode number configuration application initiated by the MDS, allocating, by the InoTable in the primary MDS, a batch Inode number for the MDS according to the currently available Inode number resource, so that the Inode number invokes the batch Inode number to respond to several times of metadata creation requests of the client; wherein the batch Inode number comprises at least two Inode numbers.

17. The computer apparatus according to claim 9, wherein after the InoTable in the primary MDS receiving the Inode number configuration application initiated by the MDS, allocating Inode numbers for the MDS according to the currently available Inode number resource to invoke the Inode number to respond to the metadata creation request of the client, comprising:
after the InoTable in the primary MDS receiving the Inode number configuration application initiated by the MDS, allocating the Inode numbers for the MDS from the currently available Inode number resource according to an order that an allocated priority recovery node is higher than the unallocated node number to invoke the Inode number to respond to the metadata creation request of the client.

18. The computer-readable storage medium according to claim 10, wherein after the InoTable in the primary MDS receiving the Inode number configuration application initiated by the MDS, allocating Inode numbers for the MDS according to the currently available Inode number resource to invoke the Inode number to respond to the metadata creation request of the client, comprising:
after the InoTable in the primary MDS receiving the Inode number configuration application initiated by the MDS, allocating, by the InoTable in the primary MDS, a batch Inode number for the MDS according to the currently available Inode number resource, so that the Inode number invokes the batch Inode number to respond to several times of metadata creation requests of the client; wherein the batch Inode number comprises at least two Inode numbers.

19. The computer-readable storage medium according to claim 10, wherein after the InoTable in the primary MDS receiving the Inode number configuration application initiated by the MDS, allocating Inode numbers for the MDS according to the currently available Inode number resource to invoke the Inode number to respond to the metadata creation request of the client, comprising:
after the InoTable in the primary MDS receiving the Inode number configuration application initiated by the MDS, allocating the Inode numbers for the MDS from the currently available Inode number resource according to an order that an allocated priority recovery node is higher than the unallocated node number to invoke the Inode number to respond to the metadata creation request of the client.

20. A computer apparatus, comprising:
a processor; and
a memory, storing a computer program that is executed by the processor, and upon execution by the processor, is configured to cause the processor to implement the steps of the method for managing allocation of Inode numbers of the distributed storage system according to claim 5.

21. The computer apparatus according to claim 20, wherein on the condition that the client connection abnormality is detected, informing the InoTable to recover unused Inode numbers in the client comprises:
on the condition that it is detected that the client mount point is uninstalled or power is lost to disconnect the link, determining that the client connection is abnormal, and informing the InoTable to recover the unused Inode numbers in the client.

22. A computer-readable storage medium, storing a computer program that is executed by a processor, and upon execution by the processor, is configured to cause the processor to implement the steps of the method for managing allocation of Inode numbers of the distributed storage system according to claim 5.

23. The computer-readable storage medium according to claim 22, wherein on the condition that the client connection abnormality is detected, informing the InoTable to recover unused Inode numbers in the client comprises:
on the condition that it is detected that the client mount point is uninstalled or power is lost to disconnect the link, determining that the client connection is abnormal, and informing the InoTable to recover the unused Inode numbers in the client.
